(19) United States
(12) Patent Application Publication
(10) Pub. No.: US 2021/0321698 A1
(43) Pub. Date: Oct. 21, 2021

(54) HEMP PROTECTIVE FACE MASK

(71) Applicant: Armando C. Ramos, Tucson, AZ (US)

(72) Inventor: Armando C. Ramos, Tucson, AZ (US)

(21) Appl. No.: 17/365,494

(22) Filed: Jul. 1, 2021

Related U.S. Application Data
(60) Provisional application No. 63/055,197, filed on Jul. 22, 2020.

(51) Int. Cl. A41D 13/11; A41D 31/30

(52) U.S. Cl. CPC A41D 13/1192; A41D 13/113; A41D 31/305

(57) ABSTRACT

A face mask completely made from hemp fabric.

### CROSS-REFERENCE TO RELATED APPLICATIONS

This application claims priority to the U.S. provisional patent application Ser. No. 63/055,197, filed on Jul. 22, 2020, which is incorporated herein by reference in its entirety.

### FIELD OF INVENTION

The present invention relates to a face mask, and more particularly, the present invention relates to a biodegradable face mask made from hemp that has a long life and prevents the growth of microbes including molds.

### BACKGROUND

Face masks are known in the art for at least covering the nose and mouth openings of a human face. Face masks can be used for a range of purposes, but primarily a face mask forms a porous barrier between the atmosphere and the cavities of the nose and mouth. The physical characteristics of the porous barrier can be changed to control what can pass through the pores of the face mask. In general, the face mask acts as a filter that can retain particles of sizes larger than the size of the pores of the face mask. Face masks of different pore sizes are available commercially for different purposes. In brief, the known face masks act as a filter for airborne particles including microbes.

Face masks are generally available for one-time use and reusable. The one-time face masks, also known as disposable face masks, can be discarded after use. Reusable face masks are washable and can be used a limited number of times. With each wash, the face masks degrade and lose their efficiency after few wash cycles. The reusable face mask is costly in comparison to the disposable face mask. Thus, the known face masks suffer from some major drawbacks like short life, loss of efficiency with each wash, microbes get collected in the pores of the face mask and can become a source of contamination and can be environment unfriendly by not degrading or taking a very long time.

Thus, a need is appreciated for a face mask that is devoid of the aforesaid drawbacks of the known face masks.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a face mask made from organic material.

It is another object of the present invention that the material of the face mask prevents the growth of microbes.

It is still another object of the present invention that the face mask can filter out most microbes including bacteria and viruses.

It is a further object of the present invention that the face mask is reusable and has a very long life of about one year.

It is a further object of the present invention that the face mask is biodegradable.

It is still a further object of the present invention that the face mask acts as a protective barrier against ultraviolet radiations.

In one aspect, disclosed is a face mask made from a panel configured to cover the nose and mouth of a wearer; at least one strip coupled to the panel and configured to permit wearing of the face mask; a lining along a periphery of the panel; and a thread for coupling the lining and the at least one strip to the panel, wherein the panel, the at least one strip, and the thread are made from hemp. In one implementation, the face mask has two strips. In one implementation, the panel consists of 3 layers of hemp fabric pieces. In one implementation, the panel consists of 5 layers of hemp fabric pieces.

In one aspect, disclosed is a method of producing a face mask including the steps of providing a hemp fabric piece of a shape and size to form a panel of a face mask, wherein the panel is configured to cover a nose and a mouth; lining a periphery of the panel with a liner, the liner made from hemp fabric; and coupling one or more strips to the panel of a face mask, the one or more strips configured to secure the face mask over the face of the wearer, wherein the panel of the face mask, the lining, and the one or more strips are sewn using a thread made from hemp. In one implementation, the panel can include 3 layers of the hemp fabric piece. In one implementation, the panel can include 5 layers of the hemp fabric piece.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the face mask, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a face mask made from hemp material that is reusable and has a very long life. The face mask can be washed with negligible degradation of efficiency, and thus can be used for a long time. The disclosed face mask can be made from hemp material that is both organic and biodegradable. Moreover, the material of the face mask prevents the growth of trapped microbes in the pores of the face mask. Thus, the disclosed face musk is aseptic that can prevent the growth of microbes and molds in the face mask. This allows the face mask to be used for a longer time without washing. The material of the face mask can include natural terpenes including ocimene, pinene, and like that has antibacterial and antiviral properties. Hemp is known to have hundreds of such terpenes.

In one exemplary embodiment, the disclosed face mask can be completely made from hemp material. The steps in making the face mask can include cutting a hemp fabric piece of desired shape and size known to a skilled person for making a face mask. The lining of hemp material can be used around the hemp fabric piece. Also, the strips made from hemp can be provided and the components can be sewn together using a hemp thread to make the face mask. The disclosed face mask can have multiple layers of the hemp fabric for desired filtration capabilities, such as N80 and N99. The disclosed face mask has been evaluated for filtration efficiency and was found to be capable of filtering particles as low as one half micron in size and a delta p (breathability) rating of 0.06 WC at 50 CFM per minute.

Unlike the cotton fibers that break down and the mask tends to feel ragged and worn out after a few washes, the fibers of hemp have better qualities for a face mask: strong, tensile strength, and endurance. Hemp is both organic and biodegradable. Moreover, the hemp fabric becomes softer with each wash and provides a naturally yielding comfort. Since hemp fabric is naturally antimicrobial, it smells better for longer than cotton without the growth of any mold and mildew. Moreover, hemp can be effective in blocking both UV-A and UV-B rays. Additionally, the disclosed face mask can have moisture-wicking properties adding to the comfort.

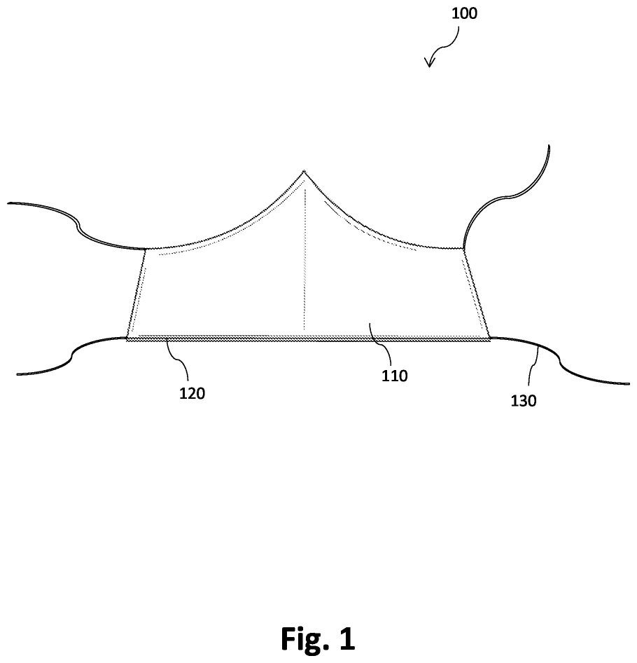

Referring to FIG. 1 which discloses the face mask 100 made from hemp having a multilayer panel 110 and a lining 120 running around a periphery of the panel 110. Four strips 130 can be seen coupled to the four corners of panel 110. The four strips can be replaced by elastic bands without departing from the scope of the present invention. Moreover, two ear loops can also be provided instead of four tie-down straps.

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A face mask consisting essentially of:
a panel configured to cover a nose and a mouth of a wearer;
at least one strip coupled to the panel and configured to permit wearing the face mask over a face;
a lining along a periphery of the panel; and
a thread for coupling the lining and the at least one strip to the panel,
wherein the panel, the at least one strip, and the thread are made from hemp.

2. The face mask according to claim 1, wherein the face mask has four strips.

3. The face mask according to claim 1, wherein the panel consists of 3 layers of hemp fabric pieces.

4. The face mask according to claim 1, wherein the panel consists of 5 layers of hemp fabric pieces.

5. A method of producing a face mask, the method comprising the steps of:
providing a hemp fabric piece of a shape and size to form a panel of the face mask, wherein the panel is configured to cover a nose and a mouth of a face;
lining a periphery of the panel with a liner, the liner made from hemp fabric; and
coupling one or more strips to the panel of the face mask, the one or more strips configured to secure the face mask over the face,
wherein the panel of the face mask, the lining, and the one or more strips are sewn using a thread made from hemp.

6. The method according to claim 5, wherein the panel consists of 3 layers of the hemp fabric piece.

7. The method according to claim 5, wherein the panel consists of 5 layers of the hemp fabric piece.
